(19) United States
(12) Patent Application Publication
(10) Pub. No.: US 2019/0381643 A1
(43) Pub. Date: Dec. 19, 2019

(54) FASTENER DRIVING TOOL HAVING DEGASSING POWER ASSEMBLY

(71) Applicant: Illinois Tool Works Inc., Glenview, IL (US)

(72) Inventor: Chinbay Q. Fan, Chicago, IL (US)

(21) Appl. No.: 16/436,392

(22) Filed: Jun. 10, 2019

Related U.S. Application Data
(60) Provisional application No. 62/685,012, filed on Jun. 14, 2018.

(51) Int. Cl. B25C 1/04

(52) U.S. Cl. CPC B25C 1/047

(57) ABSTRACT

Various embodiments of the present disclosure provide a powered fastener driving tool with a degassing/desorption/decomposition power assembly.

### PRIORITY

This application claims priority to and the benefit of U.S. Provisional Patent Application No. 62/685,012, filed Jun. 14, 2018, the entire contents of which are incorporated herein by reference.

### BACKGROUND

Powered fastener driving tools are well known and commercially widely used throughout the world. Powered fastener driving tools are typically electrically powered, pneumatically powered, combustion-powered, or powder activated. Powered fastener driving tools are typically used to drive fasteners (such as nails, staples, and the like) to connect a first material, item, or workpiece to a second material, item, workpiece, or substrate.

Various known powered fastener driving tools typically include: (a) a housing; (b) a power source or supply assembly in, connected to, or supported by the housing; (c) a fastener supply assembly in, connected to, or supported by the housing; (d) a fastener driving assembly in, connected to, or supported by the housing; (e) a trigger mechanism partially in, connected to, or supported by the housing; and (f) a workpiece contactor or contacting element (sometimes referred to herein as a “WCE”) connected to or supported by the housing. The WCE is configured to engage or contact a workpiece and to operatively work with the trigger mechanism such that the WCE needs to be depressed or moved inwardly a predetermined distance with respect to the housing before activation of the trigger mechanism causes actuation of the power fastener driving tool.

Powered fastener driving tools typically have two different types of operational modes and one or more mechanisms that enable the operator to optionally select one of the two different types of operational modes that the operator desires to use for driving the fasteners. One operational mode is known in the industry as the sequential or single actuation operational mode. In this operational mode, the depression or actuation of the trigger mechanism will not (by itself) initiate the actuation of the powered fastener driving tool and the driving of a fastener into the workpiece unless the WCE is sufficiently depressed against the workpiece. In other words, to operate the powered fastener driving tool in accordance with the sequential or single actuation operational mode, the WCE must first be depressed against the workpiece followed by the depression or actuation of the trigger mechanism. Another operational mode is known in the industry as the contact actuation operational mode. In this operational mode, the operator can maintain the trigger mechanism at or in its depressed position, and subsequently, each time the WCE is in contact with, and sufficiently pressed against the workpiece, the power fastener driving tool will actuate, thereby driving a fastener into the workpiece.

As mentioned above, various known powered fastener driving tools are combustion-powered. Many combustion-powered fastener driving tools are powered by a rechargeable battery (or battery pack) and a replaceable fuel cell or cartridge. Various combustion-powered fastener driving tools, battery packs, and fuel cells have been available commercially from ITW-Paslode of Vernon Hills, Ill. (a division of Illinois Tool Works Inc., the assignee of this application).

In these combustion-powered fastener driving tools, the fuel cell or cartridge supplies fuel, and the battery provides energy to ignite the fuel. The battery powered ignition of the fuel generates a high pressure gas that moves the piston and attached driving blade to strike a fastener (such as a nail from the nail magazine).

These known combustion-powered fastener driving tools typically include a fan for supplying air, mixing the fuel and air, and purging exhaust.

Such known combustion-powered fastener driving tools are often more powerful than electrically powered or pneumatically powered fastener driving tools. Combustion-powered fastener driving tools are thus typically used for higher power required applications such as attaching a metal object to a concrete substrate wherein the fastener has to be driven through the metal object and into the concrete substrate. This is opposed to a lower powered fastener driving tool such as certain pneumatically powered tools that are used to attach one wooden member or object to another wooden member or object.

There is a continuing need to make fastener driving tools more efficient and of lighter weight. There is also a need to provide such fastener driving tools that provide the same or greater power levels as known fastener driving tools.

### SUMMARY

Various embodiments of the present disclosure provide a powered fastener driving tool having a degassing power assembly that provides necessary power levels for repeatedly driving fasteners (such as nails or staples). In various embodiments of the present disclosure, the powered fastener driving tool includes a housing that supports a piston connected to a driving blade, wherein the degassing power assembly produces rapid bursts of high pressure gas that activate the piston and the driving blade to drive the fasteners.

In various embodiments of the present disclosure, the degassing powered assembly includes an activation chamber configured to hold a media (such as a solvent) that is in a highly saturated state and that is activatable by a release mechanism (such as a heat release mechanism) to cause a rapid degassing/desorption/decomposition or release of a desired amount of gas from the highly saturated media to activate the piston. This rapid degassing/desorption/decomposition or release of the gas from the highly saturated media provides relatively high and adjustable power levels for activations of the piston and the driving blade. For purposes of this application, it should be appreciated that the media may include any suitable solvent.

In various embodiments of the present disclosure, the degassing powered assembly also causes or allows the media to rapidly re-absorb or combine with the released gas back into the media (such as on a return stroke of the piston) such that the media returns to the highly saturated state for the next activation of the piston. In various embodiments of the present disclosure, the media starts to rapidly re-absorb the released gas back into the media as soon as the gas release mechanism stops acting on the media (such as soon as the heat release mechanism stops producing the heat and cools down from side heat exchange).

Other objects, features, and advantages of the present disclosure will be apparent from the following detailed disclosure, taken in conjunction with the accompanying sheets of drawings, wherein like reference numerals refer to like parts.

### BRIEF DESCRIPTION OF THE FIGURES

FIG. 1 is a diagrammatic cross-sectional view of part of a fastener driving tool including a degassing power assembly of one example embodiment of the present disclosure.

FIG. 2 is a diagrammatic cross-sectional view of part of a fastener driving tool including a degassing power assembly of another example embodiment of the present disclosure.

### DETAILED DESCRIPTION

While the features, devices, and apparatus described herein may be embodied in various forms, the drawings show and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. This specification is intended to be taken as a whole and interpreted in accordance with the principles of the present disclosure and as understood by one of ordinary skill in the art.

Various example embodiments of the present disclosure provide a powered fastener driving tool including: (1) a housing; (2) a piston chamber in the housing; (3) a piston in the piston chamber; (4) a driver blade connected to the piston and configured to engage and drive a fastener; and (5) a degassing power assembly in the housing.

The degassing power assembly of the powered fastener driving tool of various example embodiments of the present disclosure includes: (1) an activation chamber in the housing that is configured to hold a highly saturated media; and (2) a gas release mechanism (such as a heat release mechanism or mechanical vibration mechanism) in or connected to the housing that is configured to cause a rapid degassing/desorption/decomposition process that results in a release of a desired amount of gas from the highly saturated media in the activation chamber to rapidly create a high pressure gas that activates the piston to cause the driver blade to drive a fastener (as a result of the degassing power assembly activating the release of the gas in the activation chamber). It should be appreciated that in various different embodiments of the present disclosure, the degassing process can cause a direct actuation on or of the piston (i.e., such as in part of the piston chamber) or an indirect actuation on or of the piston (i.e., such as in a separate chamber that causes an actuation of the piston).

In various embodiments of the present disclosure, the gas release mechanism includes a heat source (such as a spark plug, a glow plug, or a resistance wire) configured to apply a sudden blast of heat to the highly saturated media to cause the rapid release of the gas with/without the need for a chemical reaction. In other words, in various embodiments of the present disclosure, the degassing power assembly rapidly produces the high pressure gas needed to activate the piston with one or more spark plugs, glow plugs, or heat from a direct resistance wire, but without any of the sparks or other heat igniting the gas (and causing combustion of the gas) and without igniting the highly saturated media.

In various embodiments of the present disclosure, once the gas release mechanism stops causing release of the gas (such as by stopping to product sparks or other heat), the media begins to rapidly re-absorb the released gas back into the media. Thus, the liquid degassing or decomposition is fully reversible.

It should be appreciated that the powered fastener driving tool of various embodiments of the present disclosure additionally includes various other well-known components that are conventionally included in or part of a powered fastener driving tool. These components are well known to a person of ordinary skill in the art and in the powered fastener tool industry, and are thus not described herein.

In various example embodiments of the present disclosure, the degassing power assembly provides a controlled rapid release or degassing/desorption/decomposition of gas in a substantially large volume relative to the size of the activation chamber and the amount of highly saturated media in the activation chamber. In certain such embodiments, sudden heat from a heat generating device such as a specifically controlled spark plug, glow plug or resistance wire generates the heat to cause this rapid release or degassing/desorption/decomposition of gas that is employed to produce a relatively large amount of energy to actuate the piston and a driver blade to drive a fastener. In various example embodiments, the degassing power assembly controls the gas release such that the energy cause by the rapid release of the gas is transferred substantially or almost completely into the motion of the piston.

In various example embodiments of the present disclosure, the degassing power assembly provides sudden gas pressure as high as 1,000 bars (15,000 psig).

In various example embodiments of the present disclosure, the degassing power assembly generates the high pressure gas simultaneously at a millisecond to second level after activation of the trigger by the operator.

In various embodiments of the present disclosure, the degassing power assembly provides an activation chamber that is configured (such as by shape and/or size) to enhance the rapid release or degassing/desorption/decomposition of gas from the media.

In various embodiments of the present disclosure, the degassing power assembly provides an activation chamber that is configured (such as by shape and/or size) to enhance the rapid reabsorption of the gas into the media.

In various such embodiments, when the pressure drops, the temperature also drops very fast and causes particulates for drips of the liquid media to recycle back to the highly saturated state in the activation chamber.

In various example embodiments of the present disclosure, the degassing power assembly provides a pressure profile that matches the time frame needed for a fastener to be driven into a substrate.

### Example Gas Release Mechanisms of the Degassing Power Assembly

In various example embodiments of the present disclosure, the degassing power assembly employs a gas release mechanism in the form of a heat release mechanism.

In various example embodiments of the present disclosure, the heat release mechanism includes a power source that includes one or more replaceable and/or rechargeable batteries positioned in or attached (or attachable) to the housing.

In various example embodiments of the present disclosure, the heat release mechanism: (1) is electrically connected at the terminal end of the spark plug, glow plug, or the resistance wire to a suitable power source (such as one or more of the batteries); and (2) has the electrode end of the spark plug, glow plug, or active end of the resistance wire positioned in the activation chamber.

In various example embodiments, each of spark plugs or glow plugs generates sudden heat or plasma that rapidly produces high temperatures and generates turbulent convection flow to erupt the gas stored in the highly saturated media or chemicals. Each spark plug or glow plug generates high voltage that heats the dielectric fluid very fast to produce a localized very high temperature. For example, upon the voltage applied to the spark plug, the plasma may be formed with temperatures as high as 40 to 50 million degrees Celsius. Lower temperature plasma may also be employed in accordance with the present disclosure.

For a glow plug (such as an example NGK NHTC glow plug), it can generate sudden heat to reach a temperature of 1,000° C. in less than two seconds and can after-glow for more than ten minutes at temperatures of up to 1,350° C. In various embodiments of the degassing process, 70 to 200° C. temperature is enough to decompose or degas the liquid media.

In various example embodiments, the heat release mechanism includes a coiled voltage adapter configured to increase voltage from the battery to 12,000 volts to cause the spark plug(s) to generate the sudden heat in the media in the activation chamber to cause the degassing process.

In various example embodiments, the heat release mechanism includes one or more super-capacitors configured to cause the spark plug to release the high voltage for high heat generation.

In various example embodiments, the heat release mechanism includes an electrical discharge machine (EDM) by way of electric spark erosion configured to spark the dielectric solution. EDM spark erosion is similar to having an electrical short that burns a small hole in a piece of metal that it contacts. In various embodiments, EDM spark is the source for the sudden heat generation for degassing/desorption/decomposition of the media.

In various example embodiments, the heat release mechanism includes a battery powered apparatus configured to cause a glow plug or a resistance wire that generates heat to cause the degassing/desorption/decomposition of the media.

In various example embodiments, the heat release mechanism includes ohmic heating schemes that typically get the plasma to 40-50 million degrees Celsius. However, they cannot go much further as the effectiveness of ohmic heating diminishes as the plasma temperature increases.

### Example Medias and Gases for the Degassing Power Assembly

In various embodiments of the present disclosure, the degassing power assembly employs a media that is in a liquid form. The liquid media is a good thermal conductor (i.e., water, glycol, and other good thermal conductive organic/inorganic liquid or gels can function as the media).

When degassing/desorption/decomposition occurs, the liquid could be vaporized as a gas, or as fine liquid drops. Ideally, the media is in a gas phase when the temperature raises. However, in various embodiments, the liquid phase is needed between the piston and sleeves to lubricate the interface.

In various embodiments of the present disclosure, the liquid media for spark plug heating has a relatively low dielectric coefficient that exhibits high electrical resistivity. The spark plug heating employs two electrodes immersed in the liquid media in various embodiments. As the dielectric constant increases, the electric flux density increases (the total amount of electrical charge per area increases). At low dielectric coefficient, the electrical charge targets the impurities (such as gas sorbent materials and/or trapped gas bubbles for decomposition) rather than the liquid media. Thus, the gas (bubbles or chemical decomposition) erupts to generate sudden high pressure. If the dielectric constant is high, the media shorts the electrical loop and wastes the electrical energy for the media although it can heat the liquid up. In certain example embodiments, the heating for the media takes time and may generate enough temperature for degassing. In certain embodiments, the low dielectric coefficient media reduce the media decomposition and burning. High viscosity media tends to hinder the bubble release because of the high surface tension. Low viscosity liquid tends to have easier bubble release

In various example embodiments of the present disclosure, the liquid media includes a mineral oil such as food grade mineral oil such as Drakeol series.

In various example embodiments of the present disclosure, the liquid media includes water based mixture with organic and/or inorganic solutes.

In various example embodiments of the present disclosure, the liquid media includes an amine based solvent for carbon dioxide adsorption.

In various example embodiments of the present disclosure, the liquid media includes glycol and specifically for example glycerol.

In various example embodiments of the present disclosure, the gas includes an inert gas.

In various example embodiments of the present disclosure, the gas includes an inert gas such as: (1) carbon dioxide (CO₂); (2) nitrogen oxides (such as NO, NO₂, and N₂O₄); and (3) combinations of carbon dioxide and nitrogen oxides.

In various example embodiments of the present disclosure, the gas containing material includes one or more of CO₂, ammonia, nitrogen oxides and/or related gas-generating chemicals, such as sodium bicarbonate (baking soda), sodium carbonate, ammonium bicarbonate, ammonium carbonate, ammonium nitrate, earth metal azide, etc.

More specifically, in various example embodiments of the present disclosure, the gas containing material is ammonium bicarbonate dissolved in glycerol to form a 10% solution. The ammonium bicarbonate decomposition: NH₄HCO₃⇄NH₃+H₂O+CO₂ of 1 mole of ammonium bicarbonate generates 3 moles of gas phase ammonia, water vapor and carbon dioxide. For example, 5 g (0.0794 moles) of ammonium bicarbonate dissolves in 50 ml glycerol to produce 0.238 moles of gas. For example, if the container is 50 ml, the pressure at 100° C. is 145 atm. If the water is liquid at 25° C., 77.6 atm pressure is generated. This pressure is much more than 150 psi (10 atm) needed for striking a fastener.

Another example is:

Na₂CO₃(s)+CO₂(g)+H₂O(g)⇄2NaHCO₃ ΔH=−129.1 kJ/mol

NaHCO₃ decomposes to Na₂CO₃, H₂O and CO₂ in the temperature range of 100° C.-200° C. 2 moles of NaHCO₃ produce 1 mole of CO₂ gas. 5 g (0.0595 moles) of NaHCO₃ produces 0.02975 moles or 666 ml of CO₂ at 1 atm, which if at 50 ml, the pressure would be 13.3 atm or 200 psi and can be used for causing the driving of a fastener.

In various example embodiments of the present disclosure, the gas is a carbon dioxide and the solvent includes a polyethylene glycol dimethyl ether that absorbs carbon dioxide at a pressure in the range of 300 to 2000 psia (2.07 to 13.8 MPa), which was tested for the carbon dioxide capture from simulated coal fired power plants.

In other various example embodiments of the present disclosure, the gas is a carbon dioxide and the solvent includes a Selexol™ that absorbs carbon dioxide at a pressure in the range of 300 to 2000 psia (2.07 to 13.8 MPa).

In other various example embodiments of the present disclosure, the gas is a carbon dioxide and the solvent includes a NMP (N-methyl-2-pyrrolidone) that absorbs carbon dioxide at a pressure in the range of 300 to 2000 psia (2.07 to 13.8 MPa).

In other various example embodiments of the present disclosure, the gas is a carbon dioxide and the solvent includes a piperazine that absorbs carbon dioxide at a pressure in the range of 300 to 2000 psia (2.07 to 13.8 MPa).

In various other example embodiments of the present disclosure, the degassing/desorption/decomposition assembly employs a media that is in a solid form, and particularly in a powder form.

In various example embodiments of the present disclosure, the solid media includes one or more of ammonium bicarbonate, ammonium nitrate, sodium bicarbonate, sodium carbonate, sodium nitrate, earth metal azide (reversible material), and other materials, which decompose to generate gases.

In various example embodiments, the gas and the media are both environmental friendly and non-toxic.

### Example Tool Configurations

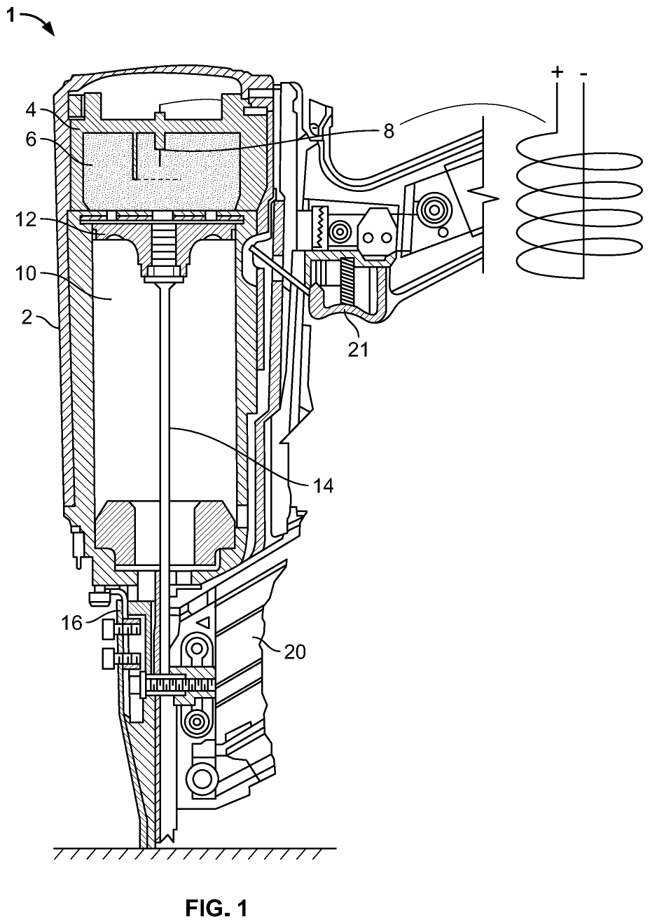

Referring now to FIG. 1, a diagrammatic cross-sectional configuration for part of a fastener driving tool with the degassing power assembly of one example embodiment of the present disclosure is generally shown. In this illustrated example embodiment, the fastener driving tool is generally indicated by numeral 1. The fastener driving tool 1 generally includes: (a) a housing 2; (b) an activation chamber 4 in the housing 2; (c) a highly saturated solvent 6 in the activation chamber 4; (d) a spark plug 8 extending into the activation chamber 4; (e) a piston chamber 10 in the housing 2; (f) a piston 12 in the piston chamber 10; (g) a fastener driving blade 14 connected to the piston 12 and partly disposed in the piston chamber 10, and configured to engage and drive fasteners from a magazine 20; (h) a work piece contact element 16; and (i) a trigger 21 that is part of a trigger assembly.

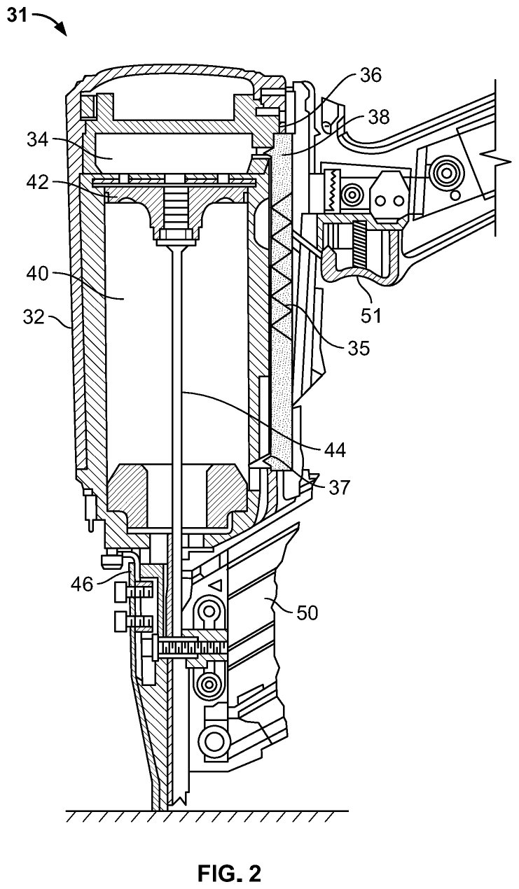

Referring now to FIG. 2, a diagrammatic cross-sectional configuration for part of a fastener driving tool with the degassing power assembly of another example embodiment of the present disclosure is generally shown. In this illustrated example embodiment, the fastener driving tool is generally indicated by numeral 31. The fastener driving tool 31 generally includes: (a) a housing 32; (b) a piston chamber 34 in the housing 32; (c) a highly saturated solvent activation chamber or tank 38 configured to hold a solvent and adjacent to or at the side of activation chamber 34; (d) a resistance wire 35 extending in the activation chamber 38; (e) a piston chamber 40 in the housing 32; (f) a piston 42 in the piston chamber 40; (g) a fastener driving blade 44 connected to the piston 42 and partly disposed in the piston chamber 40, and configured to engage and drive fasteners from a magazine 50; (h) a work piece contact element 46; and (i) a trigger 51 that is part of a trigger assembly. The example fastener driving tool 31 further includes an on/off valve 36 and check valve 37. In this configuration, a suitable battery (that is not shown) provides the electricity to generate heat through the resistance wire 35. The degassing/desorption/decomposition occurs in the activation chamber 38. When the WCE is activated, the battery powers the resistance wire which in turn generates a designated amount of high pressure gas from the solvent. When the trigger 51 is pulled or activated, the valve 36 opens to enable the high pressure gas to move into the piston chamber 34 to act on the piston 42 and cause the piston 42, causing the fastener driving blade 44 to move to strike a fastener (not shown). Once the piston 42 reaches a vent area, the check valve 37 opens to push the exhaust into the activation chamber 38. This provides a closed cycle that does not lose any active gas or like agent. This configuration enables slow degassing to store the gas in the activation chamber 38 for use. In this illustrated example embodiment, the degassing power assembly is a closed system.

### Various Uses and Advantages

It should be appreciated that the degassing power assembly of various example embodiments of the present disclosure can be employed in or with stand-alone power tool or a hybrid pneumatic power tool. In other words, it should be appreciated that the disclosed degassing power assembly can be used in pneumatic tools as well as cordless tools.

In certain such example pneumatic tool embodiments, the degassing power assembly is employed or starts to work when the air hose that supplies pressurized air to the pneumatic tool is disconnected. Thus, for these pneumatic tools, the hose can be disconnected anytime if needed. Once the hose is disconnected, the degassing power assembly gas generation is in the active mode and the tool can be used with the pneumatic air supply.

It should be appreciated that the degassing power assembly of the present disclosure can eliminate the need for a motor and fan for air inlet and an exhaust that are needed in combustion powered fastener driving tools.

It should be appreciated that the degassing power assembly of the present disclosure can reduce the weight of the power tools in part by reducing the activation chamber size. Certain known powered fastener driving tools have a 1 to 1 ratio of the piston chamber size versus the combustion chamber size. The reason for the large combustion chamber is due to the pressure produced from the ignition of the fuel. The pressure from the spark ignition is often around 100 psi. From this ratio, various embodiments of the present disclosure can produce pressure at 100 psi or even higher, and thus the activation chamber size can be substantially smaller than a combustion chamber size for similar power outputs.

In various example embodiments, a fastener driving tool having a combustion chamber of 262 ml that provide 500 psi can be replaced with a fastener driving tool having an activation chamber of 44.3 that provides 591psi.

In various example embodiments, a fastener driving tool having a combustion chamber of 262 ml that provide 500 psi can be replaced with a side reservoir, which can hold the pressure for release to strike a fastener.

It should be appreciated that the terms degassing, desorption, and decomposition are used herein to represent the same process.

It will be understood that modifications and variations may be effected without departing from the scope of the novel concepts of the present invention, and it is understood that this application is to be limited only by the scope of the claims.

The invention is claimed as follows:

1. A powered fastener driving tool comprising:
a housing;
a piston chamber in the housing;
a degassing power assembly in the housing and including: (i) a gas release mechanism, and (ii) an activation chamber in or adjacent to the housing;
a piston disposed in the piston chamber; and
a fastener driving blade connected to the piston and configured to engage and drive a fastener upon the gas release mechanism causing a degassing of gas from a highly saturated media in the activation chamber.

2. The powered fastener driving tool of claim 1, wherein the gas release mechanism includes one of a heat release mechanism and a mechanical vibration release mechanism.

3. The powered fastener driving tool of claim 1, wherein the gas release mechanism includes a battery and one of a spark plug, glow plug, and a resistance wire.

4. The powered fastener driving tool of claim 1, wherein the gas is selected from the group consisting of: (a) carbon dioxide; (b) nitrogen oxide; (c) ammonia; and (d) nitrogen.

5. The powered fastener driving tool of claim 1, wherein the media is one of a liquid and a colloid.

6. The powered fastener driving tool of claim 1, wherein the media is a liquid selected from the group consisting of: water, a mineral oil, a transformer oil, a glycerol, and a xylene.

7. The powered fastener driving tool of claim 1, wherein the media is a solid.

8. The powered fastener driving tool of claim 1, wherein the media is a solid selected from the group consisting of: carbonates, nitrates, azides, and ammonia based salts.

9. The powered fastener driving tool of claim 1, wherein the gas release mechanism is configured to allow the rapid absorption of the gas back into the media in the activation chamber.

10. The powered fastener driving tool of claim 1, wherein the gas release mechanism is configured to allow a rapid absorption of the gas back into the media in the activation chamber.

11. The powered fastener driving tool of claim 1, wherein the degassing process is reversible into a gas absorption process.
